(19) United States
(12) Patent Application Publication
(10) Pub. No.: US 2003/0043980 A1
(43) Pub. Date: Mar. 6, 2003

(54) Apparatus for automatically selecting a telephone service provider and method thereof

(76) Inventor: Jung-Gu Kang, Pusan (KR)

Correspondence Address: HARNESS, DICKEY & PIERCE, P.L.C., P.O. BOX 828, BLOOMFIELD HILLS, MI, 48303, US

(21) Appl. No.: 09/946,803

(22) Filed: Sep. 5, 2001

(51) Int. Cl. H04M 15/00

(52) U.S. Cl. 379/114.09; 379/112.07; 379/121.01; 379/114.02

(57) ABSTRACT

An apparatus for automatically selecting a telephone service provider that provides a communication service at the most inexpensive fee schedule and a method thereof are disclosed. According to the apparatus and the method, a telephone service provider that provides a communication service at the most inexpensive fee schedule is automatically selected according to the predetermined area, time and provider codes corresponding to a connection signal inputted by the calling part. This effectively provides a telephone service to a user at the lower rate.

### BACKGROUND OF THE INVENTION

1. Field of the Invention

The present invention relates to a telephone, more particularly to an apparatus that can automatically select a telephone service provider and a method thereof.

2. Prior Art

In recent years, the Internet has generally been used for international calls. A conventionally international call using the Internet uses a mechanism as follows: A public switched telephone network (PSTN) selected by a caller is connected with an Internet phone gateway constructed at each area or country. And, the internet phone gateway is connected with another foreign Internet phone gateway, and the foreign Internet phone gateway is connected through another PSTN with a called telephone.

And, the gateways are provided by a basic communication provider, a particular communication provider or a foreign communication provider.

The international call using the gateway provider networks has the advantages that communication can be established a without regard to any time or place and no particular equipment is needed. However, these international calls using the Internet are also charged for using communication networks provided by commercial communication providers. And, the network providers have various fee schedules that are different from one another. Further, it is generally difficult to select one among the commercial communication providers that provides a communication service at lower rates.

### SUMMARY OF THE INVENTION

The present invention has been developed by taking the above facts into consideration, and an object of the present invention is to provide an apparatus for automatically selecting a telephone service provider that provides a communication service with the most inexpensive fee schedule and a method thereof.

In order to achieve the above objects, an apparatus according to one aspect of the present invention includes: a telephone for generating a called telephone number and a connecting signal, the connecting signal including an area code, a time code, and a provider code; a telephone signal detecting part for detecting a hook signal generated from the telephone; a code signal processing part for converting the area code, the time code, and the provider code which are inputted from the telephone when the telephone signal detecting part detects the hook signal, wherein the code signal processing part includes a telephone matching part for converting the area code, the time code, and the provider code to store the area code, the time code, and the provider code, a signal receiving part for receiving a signal outputted from the telephone matching part, and a sound transmitting part for providing a sound signal to the telephone matching part; a control part for storing the area code, the time code, and the provider code, requesting a call to a provider network corresponding to a telephone number of a called part and a time, and establishing the call between the called part and the telephone through the provider network, wherein the control part includes a database for storing the telephone number, the area code, the time code, and the provider code, a timer for matching a time corresponding to the time code with a current time, and a calendar for matching a date corresponding to the time code with a current date; a first switching part which is switched either on or off according to a first control signal generated from the control part in order to establish a call according to the provider code and the telephone number, the first switching part for outputting a call signal provided from the telephone; a second switching part which is switched either on or off according to a second control signal generated from the control part, the second switching part for outputting a network signal provided from a switching center; a network signal detecting part for detecting the network signal; and a network signal Processing part for converting the network signal inputted from the second switching part to be stored in the control part when the network signal detecting part detects the network signal.

A method according to another aspect of the present invention includes the steps of: a) determining whether a hook signal and a storing signal are inputted from a telephone; b) storing a connecting signal which inputted from telephone when an the step a), the hook signal and the storing signal are inputted from the telephone, the connecting signal including an area code, a time code, and a provider code; and c) requesting a call using a provider network having a provider code which is matched with an area number included in a telephone number of a called part provided from the telephone and the area code stored in the step b) when in the step a) , the stored signal is not inputted, wherein the step b) includes the steps of: b-1) determining whether the hook signal is detected when the storing signal is inputted in the step a); b-2) either inputting a password after switching off a second switching part when the hook signal is detected, or switching off a first switching part when the hook signal is not detected; b-3) determining whether the password inputted in the step b-2) matches a previously stored password; and b-4) storing the area code, the time code, and the provider code of the connecting signal for an automatic dialing when the password matches the previously stored password.

Further, the step c) includes the steps of: c-1) inputting the telephone number; c-2) temporarily storing the telephone number; c-3) requesting a call according to the telephone number to the provider network corresponding to the telephone number; and c-4) establishing the call between the called part and the telephone through the provider network.

Preferably, the step c-3) includes the steps of: d-1) requesting the call to the provider network; d-2) determining whether the call is established between the provider network and the telephone and performing the step c-4) when the call connection is done through the provider network; and d-3) determining that the telephone number is busy when it is determined in the step d-2) that the call is not established between the provider network and the telephone, and ceasing the present process when the telephone number is busy.

Preferably, the step c-4) includes the steps of: e-1) requesting the call to the provider network according to the telephone number which is temporarily stored by the step c-2) when the requesting the call to the provider network succeeds in the step c-3) ; e-2) determining whether the call is established with the called part by the step e-1); e-3) communicating with the called part when the call is established with the called part in the step e-2); and e-4) determining whether a predetermined time period has passed when the call is not established with the called part in the step e-2), and ceasing the present process when the predetermined time period has passed.

### BRIEF DESCRIPTION OF THE DRAWINGS

This invention will be better understood and its various objects and advantages will be more fully appreciated from the following description taken in conjunction with the accompanying drawings, in which:

FIG. 1 is a view showing one example of an apparatus for automatically selecting a telephone service provider according to the present invention; and

FIGS. 2 and 3 are flow charts for illustrating the operation of automatically selecting a telephone provider.

### DETAILED DESCRIPTION OF THE PREFERRED EMBODIMENT

Preferred embodiments of the present invention will be illustrated below with reference to the accompanying drawings.

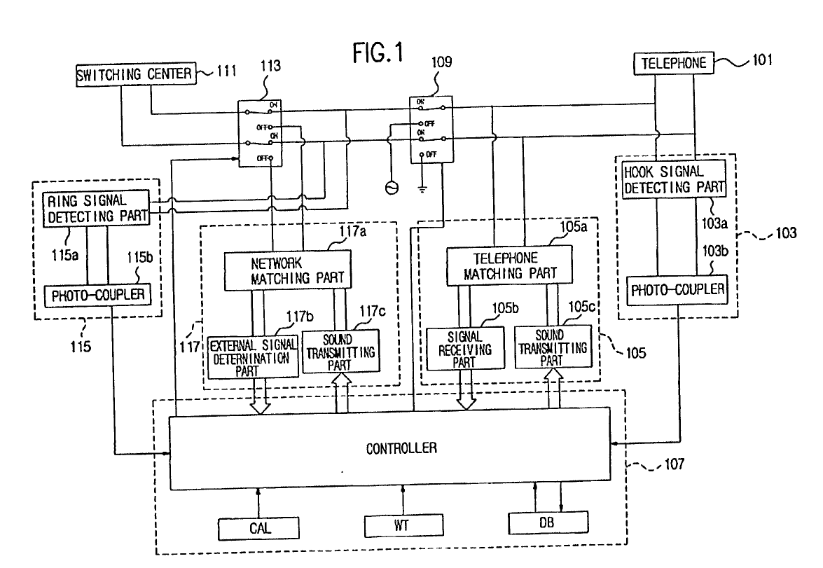

FIG. 1 is a view showing one example of an apparatus for automatically selecting a telephone service provider according to the present invention.

Referring to FIG. 1, the apparatus for automatically selecting a telephone service provider includes a telephone 101, a telephone signal detecting part 103, a telephone signal processing part 105, a control part 107, a first switching part 109, a switching center 111, a second switching part 113, a network signal detecting part 115, and a network signal processing part 117.

The telephone 101 is configured for inputting a telephone number of a called part, a predetermined area code, a predetermined time code, and a provider code. The telephone signal detecting part 103 is configured to detect a hook signal generated from the telephone 101.

The telephone signal detecting part 103 includes a hook signal detecting part 103a for detecting the hook signal generated from the telephone 101 and a first photo-coupler 103b for transmitting the hook signal to the control part 107.

On the other hand, when the hood signal is inputted to the telephone signal detecting part 103, and the telephone number, the area code, the time code and the provider code which are generated from the telephone 101 are inputted to the code signal processing part 105, the code signal processing part 105 converts the telephone number, the area code, the time code and the provider code to be stored in the control part 107. When converted codes' data are inputted to the control part 107, the control part 107 stores the converted codes' data. The control part 107 selects a service provider according to the time code and the provider code and requests a call to the selected service provider.

The code signal processing part 105 includes a telephone matching part 105a, a signal receiving part 105b, and a sound transmitting part 105c. When the telephone number, the area code, the time code and the provider code are inputted to the telephone matching part 105a, the telephone matching part 105a converts the telephone number, the area code, the time code and the provider code to be stored in the control part 107. The signal receiving part 105b receives the converted codes from the telephone matching part 105a and provides the converted codes to the control part 107. And, the sound transmitting part 105c provides a sound signal generated from the control part 107 through the telephone matching part 105a to the telephone 101.

Further, the control part 107 includes a database (DB), a clock (WT) and a calendar (CAL). The data base (DB) stores the telephone numbers the predetermined area code, the predetermined time code and the provider code provided from the telephone 101. The clock (WT) provides the control part 107 with time information needed for comparing the current time with a corresponding time to the time code. And, the calendar (CAL) provides the control part 107 with date information needed for comparing the current date with a corresponding date to the time code.

The first switching part 109 is switched either on or off according to a first control signal generated from the control part 107. When the first switching part 109 is switched on according to the first control signal, the communication link is established through the selected service provider between the telephone 101 and the called part.

The second switching part 113 is switched either on or off according to a second control signal generated from the control part 107. While the second switching part 113 is switched off according to the second control signal, the second switch 113 outputs a network signal inputted through the switching center 111. The network signal detecting part 115 detects a network signal inputted through the second switching part 113.

The network signal detecting part 115 includes a ring detecting part 115a and a second photo-coupler 115b. The ring detecting part 115a detects the network signal. The second photo-coupler 115b provides the ring signal to the control part 107.

When the network signal is detected by the network signal detecting part 115, the network signal processing part 117 processes the network signal inputted through the second switching part and outputs the processed network signal to the control part 107. The network signal processing part 117 outputs a dial signal corresponding to a telephone number stored in the control part 107.

The network signal processing part 117 includes a network matching part 117a, an exterior signal determining part 117b, and signal transmitting part 117c. The network matching part 117a converts the network signal to be stored in the control part 107. The exterior signal determining part 117b determines whether the signal provided from the network matching part 117a is the network signal or a telephone signal. And, the signal transmitting part 117c generates a dial signal corresponding to the telephone number of a called part provided from the control part 107, and transmits the dial signal to the network matching part 117a.

Hereinafter, the operation of the above embodiment will be illustrated.

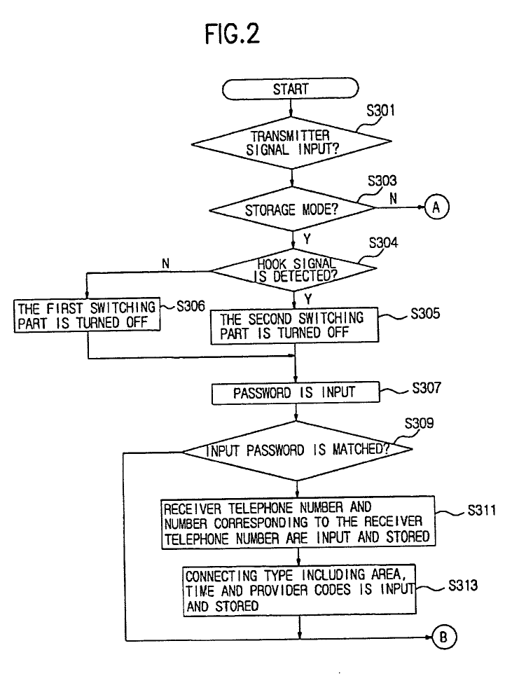

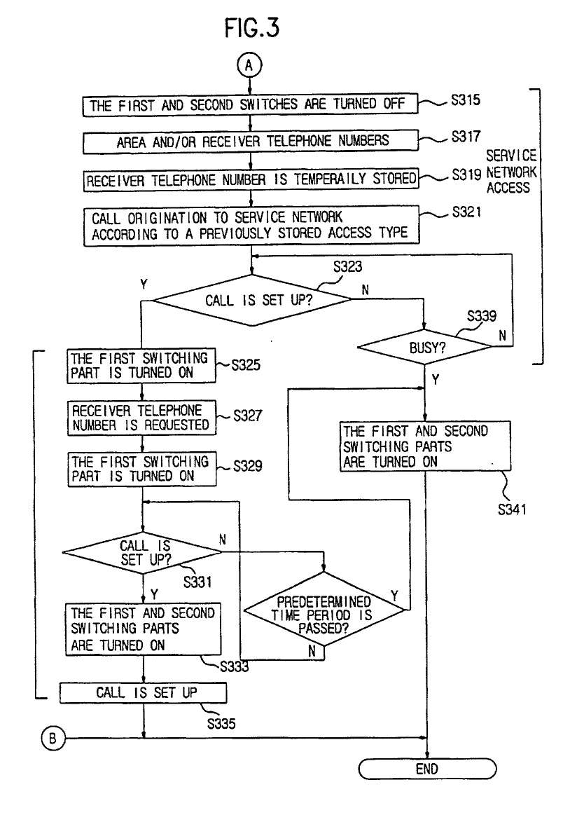

FIGS. 2 and 3 are flow charts for illustrating the operation of automatically selecting a telephone provider.

When a hook signal generated by a hook switch (not shown) of the telephone 101 is detected by the hook signal detecting part 103, the hook signal is provided through the first photo-coupler 103b to the control part 107 (S301).

The control part 107 determines whether the storing signal is inputted from a storing key thereto (S303) . When the storing mode is set by the storing signal, the control part 107 determines whether the hook signal is detected (S304). When the hook signal is detected, the control part 107 causes the second switch 113 to be switched off (S305) . However, when the hook signal is not detected, the control part 107 causes the first switch to be switched off (S306).

Thereafter, when a password is inputted from the telephone 101, the password is converted by the telephone matching part 105a and the converted password is provided through the signal receiving part 105b to the control part 107.

The control part 107 determines whether the password matches the predetermined password. When the input password is correct, the control part 107 stores the telephone number of the called part inputted from the telephone 101 in the database (DB)(S311).

Further, the control part 107 stores the area code, the time code, and the provider code inputted from the telephone 101 in the database (DB)(S3l3).

The provider code includes three places or decimals for example, ‘081’, ‘082’, ‘083’, etc., and five places of decimals for example, ‘00721’, ‘00365’, etc.

For example, if codes for ‘001 (Korea Telecom network) 1 area code) #20000600 (time code) #00727 (connecting code) #’ are inputted, these codes indecate that Internet phone of Korea Telecom is used for international calls to U.S.A. during from the time from 10 p.m. to 6 a.m.. the next day”.

If codes of ‘051 (area code) #00000000 (time code) #00721 (connecting code) #123456 (card number)’ are inputted, the code order indicates the card number (123456) of a prepaid card (00721) is automatically inputted for every call to “Busan” Korea without regard to time.

If codes of ‘0##083 (provider code)#’ are inputted, these codes indecate all domestic long distance calls, except which provider codes are previously inputted, are only transacted by ‘083 (Onse Telecom)’.

Further, if codes of ‘##00777#121212#4343#’ are inputted, these codes indecate all calls except which provider codes are previously inputted are transacted using the provider code of ‘00777’, the user ID code of ‘121212’, and the password of ‘4343’.

In the above step S303, when the control part 107 determines that the storing mode is not selected, the control part 107 generates the first and second control signals to cause the first and second switching parts 109 and 113 to be switched off (S315).

When a telephone number of a called part is inputted from the telephone 101, the telephone number is stored in the control part 107 through the telephone matching part 105a and the signal receiving part 105b (S317, S319).

The control part 107 provides the switching center 111 with a provider code through the signal transmitting part 117c, the network matching part 117a and the second switching part 113 in order to use the provider network of the provider code which is stored according to the telephone number. Therefore, the switching center 111 requests the call to the provider network corresponding to the provider code (S321).

At this time, the control part 107 determines whether the call requesting to the provider network is completed. When the call request to the provider network is completed, the control part 107 causes the first switching part 109 to be switched on (S325). Then, the control part 107 transmits the telephone number temporarily stored in the database to the provider network for calling the called part (S327).

Then, the control part 107 generates the first control signal and provides the first control signal to the first switching part 109 to be switched off (S329).

On the other hand, a network signal that was inputted through the switching center 111 and the second switching part 113 is provided through the network matching part 117a and the exterior signal determining part 117b to the control part 107. The control part 107 determines whether the call is established (S331). When the call is established, the control part 107 causes the first and second switching parts 109 and 113 to be switched on, such that the switching center 111 and the telephone 101 are directly connected with each other to establish the communication link for the call (S335).

When the call is not established, the control part 107 determines whether a predetermined time period has passed (S337). When the predetermined time period has passed, the control part 107 finishes the present process. If the predetermined time period has not passed, the control part 107 goes to the step S331.

On the other hand, when the control part 107 determines that the call is not established, the control part 107 determines whether the called part is busy (S339) . If the called part is busy, the control part 107 causes the first and second switching parts 109 and 113 to be switched on and finishes the present process.

As illustrated above, the apparatus for automatically selecting a telephone service provider and the method thereof according to the present invention make it possible to automatically select a provider network according to a predetermined area, time code and provider codes that correspond to a connecting signal inputted by a user. Therefore, it is possible to provide the telephone service to the user at the most inexpensive cost.

While this invention has been particularly shown and described with reference to particular embodiments thereof, it will be understood by those skilled in the art that various changes in form and details may be effected therein without departing from the spirit and scope of the invention as defined by the appended claims.

What is claimed is:

1. An apparatus for automatically selecting a telephone service provider which comprises:
a telephone for generating a called telephone number and a connecting signal, the connecting signal including an area code, a time code, and a provider code;
a telephone signal detecting part for detecting a hook signal generated from the telephone;
a code signal processing part for converting the area code, the time code, and the provider code which are inputted from the telephone when the telephone signal detecting part detects the hook signal,
wherein the code signal processing part includes a telephone matching part for converting the area code, the time code, and the provider code to store the area code, the time code, and the provider code, a signal receiving part for receiving a signal outputted from the telephone matching part, and a sound transmitting part for providing a sound signal to she telephone matching part;
a control part for storing the area code, the time code, and the provider code, requesting a call to a provider network corresponding to a telephone number of a called part and a time, and establishing the call between the called part and the telephone through the provider network,
wherein the control part includes a database for storing the telephone number, the area code, the time code, and the provider code, a timer for matching a time corresponding to the time code with a current time, and a calendar for matching a date corresponding to the time code with a current date;
a first switching part which is switched either on or off according to a first control signal generated from the control part in order to establish a call according to the provider code and the telephone number, the first switching part for outputting a call signal provided from the telephone;
a second switching part which is switched either on or off according to a second control signal generated from the control part, the second switching part for outputting a network signal provided from a switching center;
a network signal detecting part for detecting the network signal; and
a network signal processing part for converting the network signal inputted From the second switching part to be stored in the control part when the network signal detecting part detects the network signal.

2. A method of automatically selecting a telephone service provider which comprises the steps of:
a) determining whether a hook signal and a storing signal are inputted from a telephone;
b) storing a connecting signal which is inputted from telephone when the hook signal and the storing signal are inputted from the telephone, the connecting signal including an area code, a time code, and a provider code; and
c) requesting a call using a provider network having a provider code which is matched with an area number included in a telephone number of a called part provided from the telephone and the area code stored in the step b) when the stored signal is not inputted,
wherein the step b) includes the steps of:
b-1) determining whether the hook signal is detected when the storing signal is inputted in the step a);
b-2) either inputting a password after switching off a second switching part when the hook signal is detected, or switching off a first switching part when the hook signal is not detected;
b-3) determining whether the password inputted in the step b-2) matches a previously stored password; and
b-4) storing the area code, the time code, and the provider code of the connecting signal for an automatic dialing when in the step b-3), the password matches the previously stored password.

3. The method as claimed in claim 2, wherein said connecting signal including the area code, the time code, and the provider code is remotely inputted from a switching center.

4. The method as claimed in claim 2, wherein said step c) includes the steps of:
c-1) inputting the telephone number;
c-2) temporarily storing the telephone number;
c-3) requesting a call according to the telephone number to the provider network corresponding to the telephone number; and
c-4) establishing the call between the called part and the telephone through the provider network.

5. The method as claimed in claim 4, wherein said step c-3) includes the steps of:
d-1) requesting the call to the provider network;
d-2) determining whether the call is established between the provider network and the telephone and performing the step c-4) when the call connection is done through the provider network, and
d-3) determining that the telephone number is busy when it is determined in the step d-2) that the call is not established between the provider network and the telephone, and ceasing the present process when the telephone number is busy.

6. The method as claimed in claim 4, wherein said step c-4) includes the steps of:
e-1) requesting the call to the provider network according to the telephone number which is temporarily stored by the step c-2) when it is established to communicate with the provider network in the step c-3);
e-2) determining whether the call is established with the called part by the step e-1);
e-3) communicating with the called part when the call is established with the called part in the step e-2); and
e-4) determining whether a predetermined time period has passed when the call is not established with the called part in the step e-2), and ceasing the present process when the predetermined time period has passed.
